(19) United States
(12) Patent Application Publication
(10) Pub. No.: US 2021/0147610 A1
(43) Pub. Date: May 20, 2021

(54) THERMOSETTING COMPOSITION FOR FORMING COMPONENTS OF RIGID, GAS PERMEABLE LENSES

(71) Applicant: DSM IP Assets B.V., Heerlen (NL)

(72) Inventors: Jennifer AL-RASHID, Exton, PA (US); John Andrew ZUPANCICH, Exton, PA (US); Jayme PAULLIN, Exton, PA (US); Jacob RIFFEY, Exton, PA (US); Justin KONTRA, Exton, PA (US)

(21) Appl. No.: 16/621,571

(22) PCT Filed: Jun. 18, 2018
(86) PCT No.: PCT/US2018/038062

§ 371 Date: Dec. 11, 2019

Related U.S. Application Data
(60) Provisional application No. 62/521,959, filed on Jun. 19, 2017.
(60) Provisional application No. 62/521,964, filed on Jun. 19, 2017.

(30) Foreign Application Priority Data
Jun. 29, 2017 (EP) 17178706.2
Jun. 29, 2017 (EP) 17178709.6

(51) Int. Cl. C08G 18/75; C08G 18/73; C08G 18/66; C08G 18/61; C08G 18/48; C08G 18/38; C08G 18/32; C08G 18/24; C08G 18/10; G02B 1/04

(52) U.S. Cl. CPC C08G 18/758; G02B 1/043; C08G 18/73; C08G 18/6681; C08G 18/6677; C08G 18/6674; C08G 18/61; C08G 18/4854; C08G 18/4825; C08G 18/4808; C08G 18/3893; C08G 18/3812; C08G 18/3206; C08G 18/246; C08G 18/10; C08G 18/755

(57) ABSTRACT

Disclosed herein are compositions and kits of materials for forming a component of a rigid gas permeable lens. An exemplary composition comprises a hydroxyl terminated polyurethane pre-polymer having an average of more than one hydroxyl group per molecule comprising: i) the residue of an aliphatic diisocyanate, a block of comprising polysiloxane and a block comprising hydrophobic poly(alkylene oxide), or ii) the residue of an aliphatic diisocyanate, a block comprising fluoroalkyl or fluoroalkyl ether, and a block of comprising hydrophobic poly(alkylene oxide). The composition further comprises a free aliphatic diisocyanate and a monomeric polyol, or a propoxylate thereof. The average number of hydroxyl groups of the hydroxyl terminated pre-polymer plus the average number of hydroxyl groups of the monomeric polyol, or a propoxylate thereof is equal to from 4.5 to 5.5. Kits of materials comprising elements that when combined form the composition are also disclosed. Further disclosed are articles and ocular devices comprising components formed from the compositions or kits.

### CROSS-REFERENCE TO RELATED APPLICATIONS

This application is an international application claiming priority to U.S. Provisional Application 62/521,959, filed 19 Jun. 2017, U.S. Provisional Application 62/521,964, filed 19 Jun. 2017, European Patent Application EP17178706.2, filed 29 Jun. 2017, and European Patent Application EP17178709.6, filed 29 Jun. 2017, the entire contents of each of which is hereby incorporated by reference in its entirety.

### FIELD

The disclosed inventions pertain to compositions and kits of materials that may be useful for forming components of rigid, gas permeable lenses, methods that may be used to for form components of rigid, gas permeable lenses, and components of rigid, gas permeable lenses formed therefrom.

### BACKGROUND

Contact lenses are typically made from silicone hydrogel materials. Silicone hydrogel contact lenses seek a balance of numerous properties to achieve optimal properties and patient comfort. Examples of these properties include oxygen permeability, wettability, lubricity, biocompatibility, physical strength, low modulus, and transparency. A low modulus is important because lower modulus lenses are more likely to conform to eye curvature, thereby resulting in improved user comfort.

Although silicone hydrogels achieve excellent optical clarity and oxygen permeability, their hardness and modulus are generally too low for certain biomedical applications, such as applications involving sensors. Other candidate materials, such as silicone or fluorinated acrylates, suffer from high shrinkage and/or high post-processing costs relating to mechanical finishing of the rigid material. Furthermore, existing rigid, gas permeable lenses have good hardness and oxygen permeability, but lack processing characteristics desirable for use in certain biomedical applications.

To overcome these disadvantages, polyurethanes have been considered. Polyurethanes offer the advantages of easy handling, moldability, optical clarity, and high biocompatibility.

Polyurethane hydrogels are known to be useful in contact lenses. US2002/0032297 discloses a prepolymer prepared by reacting a mixture containing a) at least one multi-functional compound, b) at least one diisocyanate, and c) at least one diol. When reacted with water, the pre-polymer forms a hydrogel polymer which may be reaction molded to form a contact lens.

WO2004/020495 discloses a method of producing thermoplastic hydrogels for use in contact lenses comprising the step of reaction one or more of a polyethylene oxide, a polyol, and/or a polyamine with a polyisocyanate and a polyfunctional amine or polyalcohol.

Preferably, the polyol is polyethylene glycol. The thermoplastic hydrogels exhibit a high level of swelling after molding and swelling with water.

A further attempt at forming lenses from polyurethane polymers is disclosed in WO2016/005733. This document discloses a poly(ethylene glycol) (PEG) compound, a PEG-PDMS-PEG copolymer diol and/or a block copolymer of ethylene oxide and propylene oxide, a poly isocyanate compound, a polyfunctional compound having an average functionality greater than 2, and a chain extender such as di-propylene glycol.

Despite these documents, there is still a need for polyurethanes that are useful in forming components of rigid, gas permeable lenses and that are able to achieve a desired combination of optical clarity, biocompatibility, hardness, and modulus.

### SUMMARY

Although past attempts at polyurethane compositions that may be useful to form components of rigid, gas permeable lenses may achieve benefits in oxygen permeability, strength, and transparency, the hardness, modulus, and processing characteristics are insufficient for certain biomedical applications.

In accordance with an embodiment, a composition for forming a component of a rigid gas permeable lens comprises:
a. a hydroxyl terminated polyurethane pre-polymer having an average of more than one hydroxyl group per molecule comprising:
   i. the residue of an aliphatic diisocyanate, a block comprising polysiloxane and a block comprising hydrophobic poly(alkylene oxide), or
   ii. the residue of an aliphatic diisocyanate, a block comprising fluoroalkyl or fluoroalkyl ether, and a block comprising hydrophobic poly(alkylene oxide);
b. a free aliphatic diisocyanate; and
c. a monomeric polyol, or a propoxylate thereof,
wherein the average number of hydroxyl groups of the hydroxyl terminated pre-polymer plus the average number of hydroxyl groups of the monomeric polyol, or a propoxylate thereof is equal to from 4.5 to 5.5.

In accordance with an embodiment, a kit of materials kit of materials for forming a component of a rigid gas permeable lens comprises:
a. a first element comprising:
   i. a hydroxyl terminated polyurethane pre-polymer having an average of more than one hydroxyl group per molecule comprising:
      1. the residue of an aliphatic diisocyanate, a block comprising polysiloxane, and a block comprising hydrophobic poly(alkylene oxide), or
      2. the residue of an aliphatic diisocyanate, a block comprising fluoroalkyl or fluoroalkyl ether, and a block comprising hydrophobic poly(alkylene oxide);
   ii. a monomeric polyol, or a propoxylate thereof,
b. a second element comprising a free aliphatic diisocyanate, wherein the average number of hydroxyl groups of the hydroxyl terminated pre-polymer plus the average number of hydroxyl groups of the monomeric polyol, or a propoxylate thereof is equal to from 4.5 to 5.5.

### DETAILED DESCRIPTION

In accordance with an embodiment, a composition for forming a component of a rigid gas permeable lens comprises:
a. a hydroxyl terminated polyurethane pre-polymer having an average of more than one hydroxyl group per molecule comprising:
   i. the residue of an aliphatic diisocyanate, a block comprising polysiloxane and a block comprising hydrophobic poly(alkylene oxide), or
   ii. the residue of an aliphatic diisocyanate, a block comprising fluoroalkyl or fluoroalkyl ether, and a block comprising hydrophobic poly(alkylene oxide);
b. a free aliphatic diisocyanate; and
c. a monomeric polyol, or a propoxylate thereof,
wherein the average number of hydroxyl groups of the hydroxyl terminated pre-polymer plus the average number of hydroxyl groups of the monomeric polyol, or a propoxylate thereof is equal to from 4.5 to 5.5.

In an embodiment, the elements of the composition are present as a multi-component kit. A thermosetting composition is formed when two or more parts of the kit are combined. The first element of the kit comprises hydroxyl-functional components, such as the pre-polymer. The second element of the kit comprises isocyanate-functional components, such as the free aliphatic diisocyanate. In an embodiment, a first element of the kit comprises the pre-polymer and a second element of the kit comprises the free aliphatic diisocyanate.

In accordance with an embodiment, a kit of materials for forming a component of a rigid gas permeable lens comprises:
a. a first element comprising:
   i. a hydroxyl terminated polyurethane pre-polymer having an average of more than one hydroxyl group per molecule comprising:
      1. the residue of an aliphatic diisocyanate, a block comprising polysiloxane, and a block comprising hydrophobic poly(alkylene oxide), or
      2. the residue of an aliphatic diisocyanate, a block comprising fluoroalkyl or fluoroalkyl ether, and a block comprising hydrophobic poly(alkylene oxide);
   ii. a monomeric polyol, or a propoxylate thereof,
b. a second element comprising a free aliphatic diisocyanate,
wherein the average number of hydroxyl groups of the hydroxyl terminated pre-polymer plus the average number of hydroxyl groups of the monomeric polyol, or a propoxylate thereof is equal to from 4.5 to 5.5.

The average number of hydroxyl groups of the hydroxyl terminated pre-polymer plus the average number of hydroxyl groups of the monomeric polyol, or a propoxylate thereof is equal to from 4.5 to 5.5. In an embodiment, the average number of hydroxyl groups of the hydroxyl terminated pre-polymer plus the average number of hydroxyl groups of the monomeric polyol, or a propoxylate thereof is at least 4.6, at least 4.7, at least 4.8, or at least 4.9. In an embodiment, the average number of hydroxyl groups of the hydroxyl terminated pre-polymer plus the average number of hydroxyl groups of the monomeric polyol, or a propoxylate thereof is at most 5.4, at most 5.3, at most 5.2, or at most 5.1. In an embodiment, the average number of hydroxyl groups of the hydroxyl terminated pre-polymer plus the average number of hydroxyl groups of the monomeric polyol, or a propoxylate thereof is about 5.

In accordance with an embodiment, a composition for forming a component of a rigid gas permeable lens comprises a pre-polymer. A pre-polymer is a component containing a reactive functionality that can react with at least one other component of the composition or kit, and a subunit that repeats at least once. The pre-polymer is formed by reacting monomers and/or polymers separately from the other elements of the composition or kit under appropriate conditions.

The pre-polymer is hydroxyl terminated. A hydroxyl terminated pre-polymer may be formed when forming a pre-polymer from a surplus of hydroxyl substituents, such as diol monomers or polymers, relative to the other substituents of the pre-polymer. Alternatively, an hydroxyl terminated pre-polymer may be formed by reacting a diol, such as a hydrophobic poly(alkylene oxide) diol or a polymeric siloxane diol, with a isocyanate-functional polymer.

The hydroxyl terminated pre-polymer comprises one or more hydroxyl groups per molecule. In an embodiment, the hydroxyl terminated pre-polymer comprises an average of at least 1.7 hydroxyl groups per molecule, at least 1.8 hydroxyl groups per molecule, at least 1.9 hydroxyl groups per molecule, 2 hydroxyl groups per molecule, an average of at least 2.1 hydroxyl groups per molecule, or an average of at least 2.2 hydroxyl groups per molecule. In an embodiment, the hydroxyl terminated pre-polymer comprises an average of at most 3 hydroxyl groups per molecule, an average of at most 2.7 hydroxyl groups per molecule, an average of at most 2.5 hydroxyl groups per molecule, an average of at most 2.4 hydroxyl groups per molecule, an average of at most 2.3 hydroxyl groups per molecule, an average of at most 2.2 hydroxyl groups per molecule, or an average of at most 2.1 hydroxyl groups per molecule. In embodiment, the hydroxyl terminated pre-polymer comprises an average of from 1.8 to 2 hydroxyl groups per molecule.

The hydroxyl terminated pre-polymer is a polyurethane. In an embodiment, the pre-polymer is linear. Typically, the pre-polymer is linear if it comprises the reaction product of only components having two functional groups, for instance, when the pre-polymer consists of the reaction product of an aliphatic diisocyanate and a diol. In an embodiment, the pre-polymer is branched. Branching can be achieved by, for instance, incorporating a component having three or more functional groups, such as a triol or tetraol, into the composition from which the pre-polymer is formed.

The hydroxyl terminated polyurethane pre-polymer comprises either or both of i) the residue of an aliphatic diisocyanate, a block comprising polysiloxane and a block comprising hydrophobic poly(alkylene oxide), or ii) the residue of an aliphatic diisocyanate, a block comprising fluoroalkyl or fluoroalkyl ether, and a block of comprising hydrophobic poly(alkylene oxide). In an embodiment, the hydroxyl terminated pre-polymer comprises a mixture of pre-polymers having different residues of an aliphatic diisocyanate and/or different combinations of i) a block comprising polysiloxane and a block comprising hydrophobic poly(alkylene oxide) and/or ii) a block comprising fluoroalkyl or fluoroalkyl ether and a block comprising hydrophobic poly(alkylene oxide). In an embodiment, the hydroxyl terminated polyurethane pre-polymer comprises a mixture of hydroxyl terminated pre-polymers comprising at least one different block.

In an embodiment, at least 20 wt %, at least 30 wt %, at least 40 wt %, at least 50 wt %, at least 60 wt %, at least 70 wt %, at least 75 wt %, at wt 80 mol %, at wt 85 mol %, or at wt 90 mol % of the blocks in the pre-polymer are blocks comprising polysiloxane, blocks comprising hydrophobic poly(alkylene oxide), or blocks comprising fluorine. In an embodiment, at least 20 wt %, at least 30 wt %, at least 40 wt %, at least 50 t %, at least 60 wt %, at least 70 wt %, at least 75 wt %, at least 80 wt %, at least 85 wt %, or at least 90 wt % of the blocks in the pre-polymer are blocks comprising polysiloxane or blocks comprising hydrophobic poly(alkylene oxide). In an embodiment, at least 20 wt %, at least 30 wt %, at least 40 wt %, at least 50 wt %, at least 60 wt %, at least 70 wt %, at least 75 wt %, at least 80 wt %, at least 85 wt %, or at least 90 wt % of the blocks in the pre-polymer are blocks comprising hydrophobic poly(alkylene oxide) or blocks comprising fluorine.

In an embodiment, the pre-polymer has a number average molecule weight (Mn) of at least 500 g/mol, at least 750 g/mol, at least 1000 g/mol, at least 1250 g/mol, or at least 1500 g/mol. In an embodiment, the pre-polymer has a Mn of at most 10000 g/mol, at most 7500 g/mol, at most 5000 g/mol, at most 4000 g/mol, at most 3000 g/mol, at most 2000 g/mol, or at most 1500 g/mol.

Throughout this application, number and weight average molecular weight are determined by gel permeation chromatography (GPC) using polystyrene standards and N,N-dimethyl formamide (DMF) as the solvent with a column temperature of 80° C. and a refractive index detector temperature of 53° C. In the case that a molecule is not polymeric or oligomeric, the molecular weight is the sum of the atomic weights of each constituent element multiplied by the number of atoms of that element in the molecular formula.

In an embodiment, the pre-polymer comprises less than 5 wt % of hydrophilic polymer or is devoid of hydrophilic polymer. In an embodiment, the pre-polymer comprises less than 5 wt % of hydrophilic poly(alkylene oxide) or is devoid of hydrophilic poly(alkylene oxide).

The pre-polymer comprises the residue of an aliphatic diisocyanate. In an embodiment, the aliphatic diisocyanate comprises hexamethylene diisocyanate (HDI), hydrogenated methylene diphenyl diisocyanate (HMDI), or isophorone diisocyanate (IPDI). In an embodiment, the aliphatic diisocyanate consists of one or more of hexamethylene diisocyanate (HDI), hydrogenated methylene diphenyl diisocyanate (HMDI), or isophorone diisocyanate (IPDI).

The pre-polymer comprises i) a block comprising polysiloxane and a block comprising hydrophobic poly(alkylene oxide), or ii) a block comprising fluoroalkyl or fluoroalkyl ether and a block comprising hydrophobic poly(alkylene oxide). Such blocks may be formed by separate components, such as a polysiloxane diol and a hydrophobic poly(alkylene oxide) diol, or a single component, such as a copolymer diol of polysiloxane and hydrophobic poly(alkylene oxide). In an embodiment, the pre-polymer comprises a residue of a diol. In an embodiment, the pre-polymer comprises the residue of a polysiloxane diol, a fluoroalkyl or fluoroalkyl ether diol, and/or a hydrophobic poly(alkylene oxide) diol. In an embodiment, the pre-polymer comprises the residue of a polysiloxane diol and a hydrophobic poly(alkylene oxide) diol. In an embodiment, the pre-polymer comprises the residue of a fluoroalkyl or fluoroalkyl ether diol, and a hydrophobic poly(alkylene oxide) diol. The pre-polymer may comprise the residue of polymeric diols, or a mixture of a monomeric diols and polymeric diols.

In an embodiment, the pre-polymer comprises the residue of a polysiloxane diol. In embodiment, the polysiloxane diol comprises a poly(dimethylsiloxane) diol. In an embodiment, the poly(dimethylsiloxane) diol comprises a hydroxyl terminated poly(dimethylsiloxane) or hydroxylalkyl terminated poly(dimethylsiloxane).

In an embodiment, the pre-polymer comprises a block of polysiloxane having a Mn of at least 500 g/mol, at least 750 g/mol, at least 1000 g/mol, at least 1200 g/mol, or at least 1500 g/mol. In an embodiment, the pre-polymer comprises a block of polysiloxane having a Mn of at most 10,000 g/mol, at most 7,500 g/mol, at most 5,000 g/mol, at most 3,000 g/mol, or at most 2,000 g/mol.

In an embodiment, the block comprising fluoroalkyl or fluoroalkyl ether comprises the reaction product of a fluoroalkyl or fluoroalkyl ether diol. The a fluoroalkyl or fluoroalkyl ether diol may be monomeric or polymeric. In an embodiment, block comprising fluoroalkyl or fluoroalkyl ether comprises the residue of 1H, 1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, 1H,1H,11H,11H-Perfluoro-3,6,9-trioxaundecan-1,11-diol. fluorinated triethylene glycol, or fluorinated tetraethylene glycol. In an embodiment, the pre-polymer comprises a block consisting of the residue of 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, 1H,1H,11H,11H-Perfluoro-3,6,9-trioxaundecan-1,11-diol, or a mixture thereof. In an embodiment, the pre-polymer comprises a block comprising fluoroalkyl ether that consists of the residue of fluorinated triethylene glycol, fluorinated tetraethylene glycol, or a mixture thereof.

In an embodiment, the pre-polymer comprises a block comprising fluoroalkyl or fluoroalkyl ether having an Mn of at least 150 g/mol, at least 250 g/mol, or at least 500 g/mol. In an embodiment, the pre-polymer comprises a block comprising fluoroalkyl or fluoroalkyl ether having a Mn of at most 1500 g/mol, at most 1000 g/mol, or at most 850 g/mol.

The pre-polymer comprises a block comprising a hydrophobic poly(alkylene oxide). A hydrophobic poly(alkylene oxide) is a poly(alkylene oxide) that tends to repel and not absorb water, or to not be dissolvable in water. Poly(ethylene oxide) is not a hydrophobic poly(alkylene oxide).

In an embodiment, the block comprising hydrophobic poly(alkylene oxide) comprises poly(propylene oxide), poly(tetramethylene oxide), a copolymer of poly(propylene oxide) and poly(tetramethylene oxide), or a mixture thereof. In an embodiment, the block comprising hydrophobic poly(alkylene oxide) consists of poly(propylene oxide), poly(tetramethylene oxide), a copolymer of poly(propylene oxide) and poly(tetramethylene oxide), or a mixture thereof. In an embodiment, the block comprising hydrophobic poly(alkylene oxide) comprises at least 50 mol %, at least 60 mol %, at least 70 mol %, at least 80 mol %, at least 90 mol %, or 100 mol % of propylene oxide and/or tetramethylene oxide. In an embodiment, the pre-polymer comprises the residue of a hydrophobic poly(alkylene oxide) diol.

In an embodiment, the block comprising hydrophobic poly(alkylene oxide) has a number average molecule weight (Mn) of at least 150 g/mol, at least 200 g/mol, at least 250 g/mol, at least 300 g/mol, at least 350 g/mol, or at least 400 g/mol. In an embodiment, the block comprising hydrophobic poly(alkylene oxide) has a Mn of at most 1500 g/mol, at most 1200 g/mol, at most 1000 g/mol, at most 900 g/mol, at most 800 g/mol, at most 700 g/mol, at most 600 g/mol, at most 500 g/mol, or at most 450 g/mol.

In an embodiment, the pre-polymer comprises the reaction product of at least 10 wt %, at least 15 wt %, or at least 20 wt % of an aliphatic diisocyanate; and at least 20 wt %, at least 30 wt %, at least 40 wt %, at least 50 wt %, at least 60 wt %, or at least 70 wt % of diols that comprise a block comprising polysiloxane and/or a block comprising hydrophobic poly(alkylene oxide). In an embodiment, the pre-polymer comprises the reaction product of at most 50 wt %, at most 40 wt %, or at most 30 wt % of an aliphatic diisocyanate; and at most 90 wt %, at most 80 wt %, at most 70 wt %, or at most 60 wt %, of diols that comprise a block comprising polysiloxane and/or a block comprising hydrophobic poly(alkylene oxide).

In an embodiment, the pre-polymer comprises the reaction product of at least 10 wt %, at least 15 wt %, or at least 20 wt % of an aliphatic diisocyanate; and at least 30 wt %, at least 40 wt %, at least 50 wt %, at least 60 wt %, or at least 70 wt % of diols that comprise a block comprising fluoroalkyl or fluoroalkyl ether and/or a block comprising hydrophobic poly(alkylene oxide). In an embodiment, the pre-polymer comprises the reaction product of at most 50 wt %, at most 40 wt %, or at most 30 wt % of an aliphatic diisocyanate; and at most 90 wt %, at most 80 wt %, at most 70 wt %, or at most 60 wt %, of diols that comprise a block comprising fluoroalkyl or fluoroalkyl ether and/or a block comprising hydrophobic poly(alkylene oxide).

In an embodiment, the composition or kit further comprises at least 30 wt %, at least 40 wt %, at least 50 wt %, or at least 60 wt % of the pre-polymer. In an embodiment, the composition or kit comprises at most 90 wt %, at most 80 wt %, at most 75 wt %, or at most 70 wt % of the pre-polymer.

In an embodiment, the composition or kit further comprises a free aliphatic diisocyanate. In an embodiment, the free aliphatic diisocyanate comprises hexamethylene diisocyanate (HDI), hydrogenated methylene diphenyl diisocyanate (HMDI), or isophorone diisocyanate (IPDI). In an embodiment, the free aliphatic diisocyanate consists of one or more of hexamethylene diisocyanate (HDI), hydrogenated methylene diphenyl diisocyanate (HMDI), or isophorone diisocyanate (IPDI). In an embodiment, the free aliphatic diisocyanate is present in an amount of at least 5 wt %, at least 10 wt %, at least 15 wt %, or at least 20 wt %, based on the total weight of the composition or kit. In an embodiment, the free aliphatic diisocyanate is present in an amount of at most 50 wt %, at most 40 wt %, at most 30 wt %, or at most 20 wt %, based on the total weight of the composition or kit.

In an embodiment, the composition or kit further comprises a free hydrophobic poly(alkylene oxide) diol, i.e. hydrophobic poly(alkylene oxide) diol that is not incorporated into the pre-polymer. In an embodiment, the free hydrophobic poly(alkylene oxide) diol comprises poly(propylene oxide) diol, poly(tetramethylene oxide) diol, or a diol that comprises a copolymer of poly(propylene oxide) and poly(tetramethylene oxide). In an embodiment, the free hydrophobic poly(alkylene oxide) diol has a number average molecule weight (Mn) of at least 150 g/mol, at least 200 g/mol, at least 250 g/mol, at least 300 g/mol, at least 350 g/mol, or at least 400 g/mol. In an embodiment, the free hydrophobic poly(alkylene oxide) diol has a Mn of at most 1500 g/mol, at most 1200 g/mol, at most 1000 g/mol, at most 900 g/mol, at most 800 g/mol, at most 700 g/mol, at most 600 g/mol, at most 500 g/mol, or at most 450 g/mol. In an embodiment, the composition or kit comprises a free hydrophobic poly(alkylene oxide) diol having a Mn of less than 500 g/mol. In an embodiment, the free hydrophobic poly(alkylene oxide) diol is present in an amount of from 0 wt % to 15 wt %, or from 2 wt % to 10 wt %.

Mixtures of free hydrophobic poly(alkylene oxide) diols may also be present. In an embodiment, the composition or kit comprises a free hydrophobic poly(alkylene oxide) diol having a number average molecular weight of less than 500 g/mol and a free hydrophobic poly(alkylene oxide) diol having a number average molecular weight of greater than 600 g/mol.

The composition or kit comprises a monomeric polyol or a propoxylate thereof. C2-04 oxylated polyols are also monomeric polyols if they are oxylated an average of once or less per OH group, and not monomeric if they are oxylated an average of more than once per OH group. Therefore, glycerol propoxylate that is propoxylated once per OH group is both a monomeric polyol and a propoxylate of glycerol.

In embodiment, the monomeric polyol, or a propoxylate thereof is a monomeric diol, triol, or tetraol, or a propoxylate thereof. In embodiment, the monomeric polyol, or a propoxylate thereof is a monomeric triol or tetraol, or a propoxylate thereof. In an embodiment, the monomeric polyol, or a propoxylate thereof comprises ethylene glycol, diethylene glycol, propylene glycol, dipropylene glycol, glycerol, glycerol propoxylate, glycerol ethoxylate, 1,2,4-benzenetriol, 3-methyl-1,3,5-pentanetriol, pentaerythritol, pentaerythritol propoxylate, or pentaerythritol ethoxylate. In an embodiment, the monomeric polyol, or a propoxylate thereof consists of glycerol, pentaerythritol, or a mixture thereof. In an embodiment, the monomeric polyol, or a propoxylate thereof consists of glycerol propoxylate, pentaerythritol propoxylate, or a mixture thereof. In an embodiment, the monomeric polyol, or a propoxylate thereof has a molecular weight of from 90 to 500 g/mol. In an embodiment, the monomeric polyol, or a propoxylate thereof has a molecular weight of from 90 to 280 g/mol. In an embodiment, the monomeric polyol, or a propoxylate thereof is present in an amount of at least 1 wt %, at least 1.5 wt %, at least 2 wt %, or at least 2.5 wt %. In an embodiment, the monomeric polyol, or a propoxylate thereof is present in an amount of at most 12 wt %, at most 10 wt %, or at most 8 wt %.

In an embodiment, the composition or kit further comprises a chain extender. A chain extender is an alkane diol having from 2 to 20 carbon atoms, wherein one or more carbon atoms may be substituted with oxygen. If in the composition or kit, the monomeric polyol, or a propoxylate thereof, comprises three OH groups or more, then a diol that satisfies the preceding definition of a chain extender is considered a chain extender rather than a monomeric polyol, or a propoxylate thereof. Conversely, if in the composition or kit, there is no monomeric polyol, or a propoxylate thereof that comprises three OH groups or more, then a diol that satisfies the preceding definition of a chain extender is considered to be a monomeric polyol, or a propoxylate thereof, rather than a chain extender.

In an embodiment, the chain extender has a molecular weight of at least 60 g/mol, at least 70 g/mol, at least 80 g/mol, at least 90 g/mol, or at least 100 g/mol. In an embodiment, the chain extender has a molecular weight of at most 500 g/mol, at most from 400 g/mol, at most 300 g/mol, at most 200 g/mol, or at most 150 g/mol. In an embodiment, the chain extender comprises ethylene glycol, diethylene glycol, propylene glycol, dipropylene glycol, 1,3-propanediol, 1,4-butanediol, 1,5-pentanediol, 1,6-hexanediol, or 1,8-octanediol. In an embodiment, the chain extender is present in an amount of from 0 to 10 wt % of the composition or kit. In an embodiment, the chain extender is present in an amount of from 2 to 10 wt % of the composition or kit.

In an embodiment, the composition or kit comprises less than 10 wt % of hydrophilic polymer. The hydrophilic polymer may show up as free hydrophilic polymer in the solution, or may be part of the pre-polymer. In an embodiment, the composition or kit comprises less than 8 wt % of hydrophilic polymer or less than 5 wt % of hydrophilic polymer. In an embodiment, the composition or kit is devoid of hydrophilic polymer. Examples of hydrophilic polymers are poly(ethylene oxide), polyethylene glycol, polyvinylpyrrolidones, and poly(2-oxazolines). At least 51 mol % of the hydrophilic polymer comprises hydrophilic units. In an embodiment, the composition or kit comprises less than 10 wt % of poly(ethylene oxide). In an embodiment, the composition or kit comprises less than 8 wt % of poly(ethylene oxide) or less than 5 wt % of poly(ethylene oxide). In an embodiment, the composition or kit is devoid of poly(ethylene oxide).

In an embodiment, the composition or kit further comprises an isocyanate-terminated pre-polymer. An isocyanate-terminated pre-polymer may be formed similarly to the hydroxyl terminated pre-polymer, but an isocyanate-terminated pre-polymer comprises more than one isocyanate group per molecule rather than more than one hydroxyl group per molecule.

In an embodiment, the composition or kit further comprises a free siloxane diol. The free siloxane diol may be monomeric or polymeric. In an embodiment, the free siloxane diol consists of a monomeric siloxane diol. In an embodiment, the free siloxane diol consists of a polymeric siloxane diol. In an embodiment, the free siloxane diol consists of a blend of monomeric and polymeric siloxane diols.

In an embodiment, the free siloxane diol comprises a monomeric siloxane diol. In an embodiment, the free siloxane diol has a molecular weight of at least 200 g/mol or at least 300 g/mol. In an embodiment, the free siloxane diol has a molecular weight of at most 600 g/mol or at most 500 g/mol. In an embodiment, the free siloxane diol comprises 1,3-bis(hydroxypropyl)tetramethyldisiloxane, 1,3-bis(3-hydroxyisobutyl)tetramethyldisiloxane, 1,3-bis(4-hydroxybutyl)tetramethyldisiloxane, or 1,3-bis(3-(2-hydroxyethoxy)propyl)tetramethyldisiloxane.

In an embodiment, the free siloxane diol comprises a polysiloxane diol. In embodiment, the free polysiloxane diol comprises a poly(dimethylsiloxane) diol. In an embodiment, the free poly(dimethylsiloxane) diol comprises a hydroxyl terminated poly(dimethylsiloxane) or hydroxylalkyl terminated poly(dimethylsiloxane).

In an embodiment, the free siloxane diol comprises a polysiloxane diol having a Mn of at least 1000 g/mol, at least 1200 g/mol, or at least 1500 g/mol. In an embodiment, the free siloxane diol comprises a polysiloxane diol having a Mn of at least 1000 g/mol, at least 1200 g/mol, or at least 1500 g/mol. In an embodiment, the free siloxane diol comprises a polysiloxane diol having a Mn of at most 10,000 g/mol, at most 9,000 g/mol, at most 8,000 g/mol, at most 7,000 g/mol, at most 6,000 g/mol, or at most 5,000 g/mol.

In an embodiment, the free siloxane diol is present in an amount of from 0 to 20 wt %. In an embodiment, the free siloxane diol is present in an amount of from 1 to 20 wt %. In an embodiment, the free siloxane diol is present in an amount of from 1 to 10 wt %.

In an embodiment, the composition or kit further comprises a free fluorinated diol. The free fluorinated diol may be monomeric or polymeric. In an embodiment, the free fluorinated diol comprises 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, or 1H,1H,11H,11H-Perfluoro-3,6,9-trioxaundecan-1,11-diol. In an embodiment, the free fluorinated diol consists of 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H, 1H,12H,12H-Perfluoro-1,12-dodecanediol, 1H, 1H,8H,8H-Perfluoro-3,6-dioxaoctan-1,8-diol, 1H,1H,11H,11H-Perfluoro-3,6,9-trioxaundecan-1,11-diol, or a blend thereof.

In an embodiment, the free fluorinated diol is present in an amount of from 0 to 10 wt %. In an embodiment, the free fluorinated diol is present in an amount of from 1 to 10 wt %. In an embodiment, the free fluorinated diol is present in an amount of from 1 to 6 wt %.

The composition is typically curable at temperatures of from 23° C. to 100° C. In an embodiment, the composition or kit further comprises a catalyst. In an embodiment, the catalyst is stannous octoate or dibutyltin dilaurate. Amine catalysts may also be used.

In an embodiment, a component is formed from the composition. The composition may be formed by combining the elements of the kit. In an embodiment, the component has a thickness of from 1 micrometer to 1 millimeter. The formed components may be flat components, may be shaped, such as in the shape of a ring, a concave surface suitable to fit on a surface of the eye, or a convex surface. Other molded shapes, included those with surface microstructures, may also be created.

The components are typically clear or water white upon curing. In an embodiment, a component formed from the composition has a refractive index of from 1.48 to 1.515, or from 1.48 to 1.5.

In an embodiment, a component formed from the composition, after exposure to 95% relative humidity for 24 hours at 23° C., has a water content of 10 wt % or less. In an embodiment, a component formed from the composition has an elastic modulus of 500 MPa or greater. In an embodiment, a component formed from the composition has a Dk/t of from 1 to 100. In an embodiment, a component formed from the composition has a Shore D hardness of from 60 to 80.

Potential advantages of the composition are that it easily handled, has a long pot-life, has good moldability, is optically clear, and has good biocompatibility. Moreover, the high hardness and modulus may allow for mounting of electrical circuitry, such as by patterning of conductive material or flip chip mounting. In an embodiment, an ocular device comprises a component formed from the composition and an electrical circuit mounted on the component. In an embodiment, a component formed from the composition may be overmolded with a hydrogel, such as a silicone hydrogel, to yield an oxygen permeable ocular device. In an embodiment, an ocular device comprises a component formed from the composition, an electrical circuit mounted on the component, and a hydrogel material molded onto or around the component.

The Examples below further elucidate embodiments of the invention, but of course, should not be construed as in any way limiting the scope of the claims.

### EXAMPLES

The following test procedures are used in the Examples.

### Glass Transition Temperature (T_{g})

T_{g} is determined via differential scanning calorimetry (DSC). The measurements are performed using a TA Instruments Discovery Q200. Samples are cut from films. The samples are weighed and sealed in an aluminum pan. The sample is cooled from room temperature to −90° C. at a ramp rate of 10° C./min. The sample is then heated to 250° C. at 10° C./min followed again by cooling to −90° C. at 10° C./min. The sample is then heated again (second heating run) to 250° C. at 10° C./min. The T_{g} of the material is determined during this second heating run.

### Oxygen Permeability

Film samples are cut to the appropriate size and masked with foil to seal any leaks. The film thickness is measured. The film is mounted onto a Mocon OxTran 2/20 system and allowed to equilibrate to a constant gas transmission rate, utilizing compressed air as the test gas and 99% nitrogen with 1% hydrogen as the carrier gas. The humidity is kept as close to 0 as possible. The equilibrium gas transmission rate is recorded and the gas permeability in Barrer is calculated.

### Modulus

Dog bone shaped samples are punched from a film using a metal punch and a press. The samples are then submitted for mechanical testing using an Instron 5965-E2 and following ASTM D638.

### Hardness

A PTC Instruments Model #307L, ASTM Type D durometer is used. Film samples are placed on the Shore D Hardness stage opposite a 5 kg counter weight. The measurement is completed at least 10 times in different locations and the average taken.

### Refractive Index

Film samples are cut to the width of the Abbe Refractometer testing surface, with the clear edge facing the light source. Cinnamon oil (refractive index=1.53) is used as the contact liquid. The measurement is completed at 25° C. The measurement is taken at least three times and the average taken.

The components used in the Examples are shown in Table 0.1.

TABLE 0.1
Components used in the Examples

| Ref | Component | CAS# | Manufacturer |
|---|---|---|---|
| Poly- | Silanol terminated | 70131-67-8 | Gelest Inc. |
| siloxane | polydimethylsiloxane | | |
| Diol | | | |
| PTMO250 | Poly (tetrahydrofuran) | 25190-06-1 | Sigma Aldrich |
| | Mn ~250 g/mol | | |
| PPG425 | Polypropylene glycol) | 25322-69-4 | Sigma Aldrich |
| | Mn ~425 g/mol | | |
| PPG1000 | Polypropylene glycol) | 25322-69-4 | Sigma Aldrich |
| | Mn ~1000 g/mol | | |
| Glycerol | Glycerol | 56-81-5 | Alfa Aesar |
| Glycerol | Poly-G ® 76-635 - | 25791-96-2 | Monument |
| PO | Glycerol Propoxylate | | Chemical |
| HDI | hexamethylene diisocyanate | 822-06-0 | TCI America |
| HMDI | 4,4′-Diisocyanato- | 5124-30-1 | TCI America |
| | methylenedicyclohexane | | |
| IPDI | Isophorone diisocyanate | 4098-71-9 | TCI America |
| WP-260 | BAYTEC ® WP-260 - | N/A | Covestro |
| | HMDI terminated pre- | | |
| | polymer based on | | |
| | PPG; % NCO 25.8-27.0 | | |
| Fluorine | 1H,1H,6H,6H-Perfluoro-1,6- | 355-74-8 | Exfluor |
| Diol | hexanediol (2,2,3,3,4,4,5,5- | | Research |
| | Octafluoro-1,6-hexanediol) | | Corporation |
| BD | 1,4-butanediol | 110-63-4 | Sigma Aldrich |
| ED | 1,2-Ethanediol | 107-21-1 | Sigma Aldrich |
| Stannous | Stannous Octoate | 301-10-0 | Sigma Aldrich |
| Octoate | | | |
| Dibutyltin | Dibutyltin dilaurate | 77-58-7 | Sigma Aldrich |
| dilaurate | | | |

### Pre-Polymer Synthesis

Dried polysiloxane diol and hydrophobic poly(alkylene oxide) diol (<150 ppm water) are added to a 250 mL round bottom flask equipped with an overheat stirrer and a dry heating bath. The temperature of the heating bath is set to 70° C. and the temperature is monitored. Once the temperature reaches 70° C., the diisocyanate is added. The catalyst is 0.02 wt % dibutyltin dilaurate. The reaction is allowed to continue until the % NCO measured via titration matched the expected/calculated % NCO. The reaction is again allowed to react until the % NCO measured matched the % NCO desired. The obtained pre-polymers have a hydroxyl functionality of 2. The compositions of the pre-polymers are shown in Table 0.2.

TABLE 0.2
Pre-polymers

| Pre- | IPDI | HDI | HMDI | Polysiloxane | PTMO250 | Mn |
|---|---|---|---|---|---|---|
| polymer | (wt %) | (wt %) | (wt %) | Diol (wt %) | (wt %) | (g/mol) |
| PP1 | 23.5 | | | 50.0 | 26.4 | 3158 |
| PP2 | | 18.9 | | 53.0 | 28.0 | 3619 |
| PP3 | | | 26.6 | 48.0 | 25.4 | 3247 |

All compositions are generated using the following procedure. The OH functional components (PPG, PTMO, Glycerol, and Pre-polymer) are placed in an empty polypropylene mixing cup. The catalyst is then added to this mixture. The mixture is hand mixed using a disposable wooden mixer. After hand mixing, the appropriate amount of Covestro Demosdur 260 is added and the entire composition is placed into a centrifugal mixer. The mixture is mixed under vacuum at 2000 RPM and 20 kPa for 5 minutes in order to mix and degas the composition.

### Example 1

Several compositions are formed according to the above procedures. The formed compositions are shown in Table 1, below.

TABLE 1
Example 1 Compositions

| | | Pre- | | | | |
|---|---|---|---|---|---|---|
| | | Polymer | | | | Cata- |
| | BAYTEC ® | (Name, | PTMO250 | PPG650 | Glycerol | lyst |
| Exp. | WP-260 | wt %) | (wt %) | (wt %) | (wt %) | (mg) |
| 1-1 | 68.7 | PP2, 1.52 | 15.92 | 15.88 | | 12.53 |
| 1-2 | 46.99 | PP2, 1.62 | 11.28 | 40.11 | | 13 |
| 1-3 | 48.1 | PP2, 2.5 | 5.02 | 39.32 | 4.9 | 10 |

### ADDITIONAL DESCRIPTION OF EXEMPLARY EMBODIMENTS

1. A composition for forming a component of a rigid gas permeable lens comprising:
   a. a hydroxyl terminated polyurethane pre-polymer having an average of more than one hydroxyl group per molecule comprising:
      i. the residue of an aliphatic diisocyanate, a block comprising polysiloxane and a block comprising hydrophobic poly(alkylene oxide), or
      ii. the residue of an aliphatic diisocyanate, a block comprising fluoroalkyl or fluoroalkyl ether, and a block comprising hydrophobic poly(alkylene oxide);
   b. a free aliphatic diisocyanate; and
   c. a monomeric polyol, or a propoxylate thereof,
   wherein the average number of hydroxyl groups of the hydroxyl terminated pre-polymer plus the average number of hydroxyl groups of the monomeric polyol, or a propoxylate thereof is equal to from 4.5 to 5.5.
2. A kit of materials for forming a component of a rigid gas permeable lens comprising:
   a. a first element comprising:
      i. a hydroxyl terminated polyurethane pre-polymer having an average of more than one hydroxyl group per molecule comprising:
         1. the residue of an aliphatic diisocyanate, a block comprising polysiloxane, and a block comprising hydrophobic poly(alkylene oxide), or
         2. the residue of an aliphatic diisocyanate, a block comprising fluoroalkyl or fluoroalkyl ether, and a block comprising hydrophobic poly(alkylene oxide);
      ii. a monomeric polyol, or a propoxylate thereof,
   b. a second element comprising a free aliphatic diisocyanate,
   wherein the average number of hydroxyl groups of the hydroxyl terminated pre-polymer plus the average number of hydroxyl groups of the monomeric polyol, or a propoxylate thereof is equal to from 4.5 to 5.5.
3. The composition or kit according to any one of the preceding exemplary embodiments, wherein the hydroxyl terminated polyurethane pre-polymer comprises a mixture of hydroxyl terminated pre-polymers comprising at least one different block.
4. The composition or kit according to any one of the preceding exemplary embodiments, wherein the hydroxyl terminated pre-polymer comprises an average of at least 1.7 hydroxyl groups per molecule, at least 1.8 hydroxyl groups per molecule, at least 1.9 hydroxyl groups per molecule, 2 hydroxyl groups per molecule, an average of at least 2.1 hydroxyl groups per molecule, or an average of at least 2.2 hydroxyl groups per molecule.
5. The composition or kit according to any one of the preceding exemplary embodiments, wherein the hydroxyl terminated pre-polymer comprises an average of at most 3 hydroxyl groups per molecule, an average of at most 2.7 hydroxyl groups per molecule, an average of at most 2.5 hydroxyl groups per molecule, an average of at most 2.4 hydroxyl groups per molecule, an average of at most 2.3 hydroxyl groups per molecule, an average of at most 2.2 hydroxyl groups per molecule, or an average of at most 2.1 hydroxyl groups per molecule.
6. The composition or kit according to any one of the preceding exemplary embodiments, wherein the hydroxyl terminated pre-polymer comprises an average of from 1.8 to 2 hydroxyl groups per molecule.
7. The composition or kit according to any one of the preceding exemplary embodiments, wherein the pre-polymer is linear.
8. The composition or kit according to any one of the preceding exemplary embodiments, wherein the pre-polymer is branched.
9. The composition or kit according to any one of the preceding exemplary embodiments, wherein the average number of hydroxyl groups of the hydroxyl terminated pre-polymer plus the average number of hydroxyl groups of the monomeric polyol, or a propoxylate thereof is at least 4.6, at least 4.7, at least 4.8, or at least 4.9.
10. The composition or kit according to any one of the preceding exemplary embodiments, wherein the average number of hydroxyl groups of the hydroxyl terminated pre-polymer plus the average number of hydroxyl groups of the monomeric polyol, or a propoxylate thereof is at most 5.4, at most 5.3, at most 5.2, or at most 5.1.
11. The composition or kit according to any one of the preceding exemplary embodiments, wherein the average number of hydroxyl groups of the hydroxyl terminated pre-polymer plus the average number of hydroxyl groups of the monomeric polyol, or a propoxylate thereof is about 5.
12. The composition or kit according to any one of the preceding exemplary embodiments, wherein the pre-polymer comprises a block comprising polysiloxane and a block comprising hydrophobic poly(alkylene oxide).
13. The composition or kit according to any one of the preceding exemplary embodiments, wherein the pre-polymer comprises a block comprising fluorine and a block comprising hydrophobic poly(alkylene oxide).
14. The composition or kit according to any one of the preceding exemplary embodiments, wherein at least 20 wt %, at least 30 wt %, at least 40 wt %, at least 50 wt %, at least 60 wt %, at least 70 wt %, at least 75 wt %, at wt 80 mol %, at wt 85 mol %, or at wt 90 mol % of the blocks in the pre-polymer are blocks comprising polysiloxane, blocks comprising hydrophobic poly(alkylene oxide), or blocks comprising fluoroalkyl or fluoroalkyl ether.
15. The composition or kit according to any one of the preceding exemplary embodiments, wherein at least 20 wt %, at least 30 wt %, at least 40 wt %, at least 50 t %, at least 60 wt %, at least 70 wt %, at least 75 wt %, at least 80 wt %, at least 85 wt %, or at least 90 wt % of the blocks in the pre-polymer are blocks comprising polysiloxane or blocks comprising hydrophobic poly(alkylene oxide).
16. The composition or kit according to any one of the preceding exemplary embodiments, wherein at least 20 wt %, at least 30 wt %, at least 40 wt %, at least 50 wt %, at least 60 wt %, at least 70 wt %, at least 75 wt %, at least 80 wt %, at least 85 wt %, or at least 90 wt % of the blocks in the pre-polymer are blocks comprising hydrophobic poly(alkylene oxide) or blocks comprising fluoroalkyl or fluoroalkyl ether.
17. The composition or kit according to any one of the preceding exemplary embodiments, wherein the pre-polymer has a number average molecule weight (Mn) of at least 500 g/mol, at least 750 g/mol, at least 1000 g/mol, at least 1250 g/mol, or at least 1500 g/mol.
18. The composition or kit according to any one of the preceding exemplary embodiments, wherein the pre-polymer has a Mn of at most 10000 g/mol, at most 7500 g/mol, at most 5000 g/mol, at most 4000 g/mol, at most 3000 g/mol, at most 2000 g/mol, or at most 1500 g/mol.
19. In an embodiment, the pre-polymer comprises less than 5 wt % of hydrophilic polymer or is devoid of hydrophilic polymer.
20. The composition or kit according to any one of the preceding exemplary embodiments, wherein the aliphatic diisocyanate comprises hexamethylene diisocyanate (HDI), hydrogenated methylene diphenyl diisocyanate (HMDI), or isophorone diisocyanate (IPDI).
21. The composition or kit according to any one of the preceding exemplary embodiments, wherein the aliphatic diisocyanate consists of one or more of hexamethylene diisocyanate (HDI), hydrogenated methylene diphenyl diisocyanate (HMDI), or isophorone diisocyanate (IPDI).
22. The composition or kit according to any one of the preceding exemplary embodiments, wherein the block comprising a hydrophobic (polyalkylene oxide) comprises the residue of a diol comprising a hydrophobic (polyalkylene oxide).
23. The composition or kit according to any one of the preceding exemplary embodiments, wherein the block comprising polysiloxane comprises the residue of a diol comprising polysiloxane.
24. The composition or kit according to any one of the preceding exemplary embodiments, wherein the block comprising fluoroalkyl or fluoroalkyl ether comprises the residue of a diol comprising a fluoroalkyl or fluoroalkyl ether.
25. The composition or kit according to any one of the preceding exemplary embodiments, wherein the pre-polymer comprises a block comprising polysiloxane that comprises the residue of a polysiloxane diol, the polysiloxane diol comprising a hydroxyl terminated poly(dimethylsiloxane) or hydroxylalkyl terminated poly(dimethylsiloxane).
26. The composition or kit according to any one of the preceding exemplary embodiments, wherein the pre-polymer comprises a block of polysiloxane having a Mn of at least 500 g/mol, at least 750 g/mol, at least 1000 g/mol, at least 1200 g/mol, or at least 1500 g/mol.
27. The composition or kit according to any one of the preceding exemplary embodiments, wherein the pre-polymer comprises a block of polysiloxane having a Mn of at most 10,000 g/mol, at most 7,500 g/mol, at most 5,000 g/mol, at most 3,000 g/mol, or at most 2,000 g/mol.
28. The composition or kit according to any one of the preceding exemplary embodiments, wherein the pre-polymer comprises a block comprising poly(dimethylsiloxane).
29. The composition or kit according to any one of the preceding exemplary embodiments, wherein the block comprising fluoroalkyl or fluoroalkyl ether comprises the reaction product of a fluoroalkyl or fluoroalkyl ether diol.
30. The composition or kit according to any one of the preceding exemplary embodiments, wherein the pre-polymer comprises a block comprising fluoroalkyl or fluoroalkyl ether that comprises the residue of 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, 1H,1H,11H,11H-Perfluoro-3,6,9-trioxaundecan-1,11-diol. fluorinated triethylene glycol, or fluorinated tetraethylene glycol.
31. The composition or kit according to any one of the preceding exemplary embodiments, wherein the pre-polymer comprises a block consisting of the residue of 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, 1H,1H,11H,11H-Perfluoro-3,6,9-trioxaundecan-1,11-diol, or a mixture thereof.
32. The composition or kit according to any one of the preceding exemplary embodiments, wherein the pre-polymer comprises a block comprising fluoroalkyl ether that consists of the residue of fluorinated triethylene glycol, fluorinated tetraethylene glycol, or a mixture thereof.
33. The composition or kit according to any one of the preceding exemplary embodiments, wherein the pre-polymer comprises a block comprising fluoroalkyl or fluoroalkyl ether having an Mn of at least 150 g/mol, at least 250 g/mol, or at least 500 g/mol.
34. The composition or kit according to any one of the preceding exemplary embodiments, wherein the pre-polymer comprises a block comprising fluoroalkyl or fluoroalkyl ether having a Mn of at most 1500 g/mol, at most 1000 g/mol, or at most 850 g/mol.
35. The composition or kit according to any one of the preceding exemplary embodiments, wherein the block comprising hydrophobic poly(alkylene oxide) comprises poly(propylene oxide), poly(tetramethylene oxide), or a copolymer of poly(propylene oxide) and poly(tetramethylene oxide).
36. The composition or kit according to any one of the preceding exemplary embodiments, wherein the block comprising hydrophobic poly(alkylene oxide) consists of poly(propylene oxide), poly(tetramethylene oxide), a copolymer of poly(propylene oxide) and poly(tetramethylene oxide), or a mixture thereof.
37. The composition or kit according to any one of the preceding exemplary embodiments, wherein the block comprising hydrophobic poly(alkylene oxide) comprises at least 50 mol %, at least 60 mol %, at least 70 mol %, at least 80 mol %, at least 90 mol %, or 100 mol % of propylene oxide and/or tetramethylene oxide.
38. The composition or kit according to any one of the preceding exemplary embodiments, wherein the block comprising hydrophobic poly(alkylene oxide) has a number average molecule weight (Mn) of at least 150 g/mol, at least 200 g/mol, at least 250 g/mol, at least 300 g/mol, at least 350 g/mol, or at least 400 g/mol.
39. The composition or kit according to any one of the preceding exemplary embodiments, wherein the block comprising hydrophobic poly(alkylene oxide) has a Mn of at most 1500 g/mol, at most 1200 g/mol, at most 1000 g/mol, at most 900 g/mol, at most 800 g/mol, at most 700 g/mol, at most 600 g/mol, at most 500 g/mol, or at most 450 g/mol.
40. The composition or kit according to any one of the preceding exemplary embodiments, wherein the pre-polymer comprises the reaction product of:
   a. at least 10 wt %, at least 15 wt %, or at least 20 wt % of an aliphatic diisocyanate; and
   b. at least 20 wt %, at least 30 wt %, at least 40 wt %, at least 50 wt %, at least 60 wt %, or at least 70 wt % of diols that comprise a block comprising polysiloxane and/or a block comprising hydrophobic poly(alkylene oxide).
41. The composition or kit according to any one of the preceding exemplary embodiments, wherein the pre-polymer comprises the reaction product of:
   a. at most 50 wt %, at most 40 wt %, or at most 30 wt % of an aliphatic diisocyanate; and
   b. at most 90 wt %, at most 80 wt %, at most 70 wt %, or at most 60 wt %, of diols that comprise a block comprising polysiloxane and/or a block comprising hydrophobic poly(alkylene oxide).
42. The composition or kit according to any one of the preceding exemplary embodiments, wherein the pre-polymer comprises the reaction product of:
   a. at least 10 wt %, at least 15 wt %, or at least 20 wt % of an aliphatic diisocyanate; and
   b. at least 30 wt %, at least 40 wt %, at least 50 wt %, at least 60 wt %, or at least 70 wt % of diols that comprise a block comprising fluoroalkyl or fluoroalkyl ether and/or a block comprising hydrophobic poly(alkylene oxide).
43. The composition or kit according to any one of the preceding exemplary embodiments, wherein the pre-polymer comprises the reaction product of:
   a. at most 50 wt %, at most 40 wt %, or at most 30 wt % of an aliphatic diisocyanate; and
   b. at most 90 wt %, at most 80 wt %, at most 70 wt %, or at most 60 wt %, of diols that comprise a block comprising fluoroalkyl or fluoroalkyl ether and/or a block comprising hydrophobic poly(alkylene oxide).
44. The composition or kit according to any one of the preceding exemplary embodiments, wherein the composition or kit comprises at least 30 wt %, at least 40 wt %, at least 50 wt %, or at least 60 wt % of the pre-polymer.
45. The composition or kit according to any one of the preceding exemplary embodiments, wherein the composition or kit comprises at most 90 wt %, at most 80 wt %, at most 75 wt %, or at most 70 wt % of the pre-polymer.
46. The composition or kit according to any one of the preceding exemplary embodiments, further comprising a free hydrophobic poly(alkylene oxide) diol.
47. The composition or kit according to any one of the preceding exemplary embodiments, further comprising a free hydrophobic poly(alkylene oxide) diol.
48. The composition or kit according to any one of the preceding exemplary embodiments, wherein the free aliphatic diisocyanate comprises hexamethylene diisocyanate (HDI), hydrogenated methylene diphenyl diisocyanate (HMDI), or isophorone diisocyanate (IPDI).
49. The composition or kit according to any one of the preceding exemplary embodiments, wherein the free aliphatic diisocyanate consists of hexamethylene diisocyanate (HDI), hydrogenated methylene diphenyl diisocyanate (HMDI), or isophorone diisocyanate (IPDI), or a mixture thereof.
50. The composition or kit according to any one of the preceding exemplary embodiments, wherein the free aliphatic diisocyanate is present in an amount of at least 5 wt %, at least 10 wt %, at least 15 wt %, or at least 20 wt %, based on the total weight of the composition or kit.
51. The composition or kit according to any one of the preceding exemplary embodiments, wherein the free aliphatic diisocyanate is present in an amount of at most 50 wt %, at most 40 wt %, at most 30 wt %, or at most 20 wt %, based on the total weight of the composition or kit.
52. The composition or kit according to any one of the preceding exemplary embodiments, further comprising a free hydrophobic poly(alkylene oxide) diol that comprises poly(propylene oxide) diol, poly(tetramethylene oxide) diol, or a diol that comprises a copolymer of poly(propylene oxide) and poly(tetramethylene oxide).
53. The composition or kit according to any one of the preceding exemplary embodiments, further comprising a free hydrophobic poly(alkylene oxide) diol wherein at least 50 mol %, at least 60 mol %, at least 70 mol %, at least 80 mol %, at least 90 mol %, or 100 mol % of the hydrophobic poly(alkylene oxide) diol backbone is propylene oxide and/or tetramethylene oxide.
54. The composition or kit according to any one of the preceding exemplary embodiments, further comprising a free hydrophobic poly(alkylene oxide) diol wherein the free hydrophobic poly(alkylene oxide) diol consists of poly(propylene oxide) diol, poly(tetramethylene oxide) diol, a diol that comprises a copolymer of poly(propylene oxide) and poly(tetramethylene oxide), or a mixture thereof.
55. The composition or kit according to any one of the preceding exemplary embodiments, wherein the free hydrophobic poly(alkylene oxide) diol has a number average molecule weight (Mn) of at least 150 g/mol, at least 200 g/mol, at least 250 g/mol, at least 300 g/mol, at least 350 g/mol, or at least 400 g/mol.
56. The composition or kit according to any one of the preceding exemplary embodiments, wherein the free hydrophobic poly(alkylene oxide) diol has a Mn of at most 1500 g/mol, at most 1200 g/mol, at most 1000 g/mol, at most 900 g/mol, at most 800 g/mol, at most 700 g/mol, at most 600 g/mol, at most 500 g/mol, or at most 450 g/mol.
57. The composition or kit according to any one of the preceding exemplary embodiments, wherein the free hydrophobic poly(alkylene oxide) diol comprises a mixture of a hydrophobic poly(alkylene oxide) diol having a number average molecular weight of less than 500 g/mol and a free hydrophobic poly(alkylene oxide) diol having a number average molecular weight of greater than 600 g/mol.
58. The composition or kit according to any one of the preceding exemplary embodiments, wherein the free hydrophobic poly(alkylene oxide) diol is present in an amount of from 0 wt % to 15 wt % of the composition or kit.
59. The composition or kit according to any one of the preceding exemplary embodiments, wherein the free hydrophobic poly(alkylene oxide) diol is present in an amount of from 2 wt % to 10 wt % of the composition or kit.
60. The composition or kit according to any one of the preceding exemplary embodiments, wherein at least 50 mol %, at least 60 mol %, at least 70 mol %, at least 80 mol %, at least 90 mol %, or 100 mol % of the free hydrophobic poly(alkylene oxide) diol backbone is propylene oxide or tetramethylene oxide.
61. The composition or kit according to any one of the preceding exemplary embodiments, wherein the monomeric polyol, or a propoxylate thereof is a diol, triol, or tetraol.
62. The composition or kit according to any one of the preceding exemplary embodiments, wherein the monomeric polyol, or a propoxylate thereof is a triol or tetraol.
63. The composition or kit according to any one of the preceding exemplary embodiments, wherein the monomeric polyol, or a propoxylate thereof is a monomeric polyol.
64. The composition or kit according to any one of the preceding exemplary embodiments, wherein the monomeric polyol, or a propoxylate thereof comprises glycerol, glycerol propoxylate, glycerol ethoxylate, 1,2,4-benzenetriol, 3-methyl-1,3,5-pentanetriol, pentaerythritol, pentaerythritol propoxylate, or pentaerythritol ethoxylate.
65. The composition or kit according to any one of the preceding exemplary embodiments, wherein the monomeric polyol, or a propoxylate thereof comprises glycerol, glycerol propoxylate, pentaerythritol, or pentaerythritol propoxylate.
66. The composition or kit according to any one of the preceding exemplary embodiments, wherein the monomeric polyol, or a propoxylate thereof consists of glycerol, glycerol propoxylate, pentaerythritol, pentaerythritol propoxylate, or a mixture thereof.
67. The composition or kit according to any one of the preceding exemplary embodiments, wherein the monomeric polyol, or a propoxylate thereof consists of glycerol propoxylate, pentaerythritol propoxylate, or a mixture thereof.
68. The composition or kit according to any one of the preceding exemplary embodiments, wherein the monomeric polyol, or a propoxylate thereof is a monomeric polyol and has a molecular weight of from 90 to 500 g/mol.
69. The composition or kit according to any one of the preceding exemplary embodiments, wherein the monomeric polyol, or a propoxylate thereof is a monomeric polyol that has molecular weight of from 90 to 280 g/mol.
70. The composition or kit according to any one of the preceding exemplary embodiments, wherein the monomeric polyol, or a propoxylate thereof is present in an amount of at least 1 wt %, at least 1.5 wt %, at least 2 wt %, or at least 2.5 wt %.
71. The composition or kit according to any one of the preceding exemplary embodiments, wherein the monomeric polyol, or a propoxylate thereof is present in an amount of at most 12 wt %, at most 10 wt %, or at most 8 wt %.
72. The composition or kit according to any one of the preceding exemplary embodiments, wherein the composition or kit further comprises a chain extender.
73. The composition or kit according to any one of the preceding exemplary embodiments, wherein the chain extender is an alkane diol having from 2 to 20 carbon atoms, wherein one or more carbon atoms may be substituted with oxygen.
74. The composition or kit according to any one of the preceding exemplary embodiments, wherein the chain extender has a molecular weight of at least 60 g/mol, at least 70 g/mol, at least 80 g/mol, at least 90 g/mol, or at least 100 g/mol.
75. The composition or kit according to any one of the preceding exemplary embodiments, wherein the chain extender has a molecular weight of at most 500 g/mol, at most from 400 g/mol, at most 300 g/mol, at most 200 g/mol, or at most 150 g/mol.
76. The composition or kit according to any one of the preceding exemplary embodiments, wherein the chain extender comprises ethylene glycol, diethylene glycol, propylene glycol, dipropylene glycol, 1,3-propanediol, 1,4-butanediol, 1,5-pentanediol, 1,6-hexanediol, or 1,8-octanediol.
77. The composition or kit according to any one of the preceding exemplary embodiments, wherein the chain extender is present in an amount of from 0 to 10 wt % of the composition or kit.
78. The composition or kit according to any one of the preceding exemplary embodiments, wherein the chain extender is present in an amount of from 2 to 10 wt % of the composition or kit.
79. The composition or kit according to any one of the preceding exemplary embodiments, wherein the composition or kit comprises less than 10 wt % of hydrophilic polymer.
80. The composition or kit according to any one of the preceding exemplary embodiments, wherein the composition or kit comprises less than 8 wt % of hydrophilic polymer or less than 5 wt % of hydrophilic polymer.
81. The composition or kit according to any one of the preceding exemplary embodiments, wherein the composition or kit is devoid of hydrophilic polymer.
82. The composition or kit according to any one of the preceding exemplary embodiments, wherein the composition or kit comprises less than 10 wt % of poly(ethylene oxide).
83. The composition or kit according to any one of the preceding exemplary embodiments, wherein the composition or kit comprises less than 8 wt % of poly(ethylene oxide) or less than 5 wt % of poly(ethylene oxide).
84. The composition or kit according to any one of the preceding exemplary embodiments, wherein the composition or kit is devoid of poly(ethylene oxide).
85. The composition or kit according to any one of the preceding exemplary embodiments, further comprising a catalyst.
86. The composition or kit according to any one of the preceding exemplary embodiments, further comprising an isocyanate-terminated pre-polymer.
87. The composition or kit according to any one of the preceding exemplary embodiments, further comprising a free siloxane diol.
88. The composition or kit according to any one of the preceding exemplary embodiments, wherein the free siloxane diol comprises a monomeric or polymeric siloxane diol.
89. The composition or kit according to any one of the preceding exemplary embodiments, wherein the free siloxane diol comprises a blend of monomeric and polymeric siloxane diols.
90. The composition or kit according to any one of the preceding exemplary embodiments, wherein the free siloxane diol consists of a monomeric siloxane diol.
91. The composition or kit according to any one of the preceding exemplary embodiments, wherein the free siloxane diol consists of a polymeric siloxane diol.
92. The composition or kit according to any one of the preceding exemplary embodiments, wherein the free siloxane diol consists of a blend of monomeric and polymeric siloxane diols.
93. The composition or kit according to any one of the preceding exemplary embodiments, wherein the free siloxane diol comprises a monomeric siloxane diol that has a molecular weight of at least 200 g/mol or at least 300 g/mol.
94. The composition or kit according to any one of the preceding exemplary embodiments, wherein the free siloxane diol comprises a monomeric siloxane diol that has a molecular weight of at most 600 g/mol or at most 500 g/mol.
95. The composition or kit according to any one of the preceding exemplary embodiments, wherein the free siloxane diol comprises 1,3-bis(hydroxypropyl)tetramethyldisiloxane, 1,3-bis(3-hydroxyisobutyl)tetramethyldisiloxane, 1,3-bis(4-hydroxybutyl)tetramethyldisiloxane, or 1,3-bis(3-(2-hydroxyethoxy)propyl)tetramethyldisiloxane.
96. The composition or kit according to any one of the preceding exemplary embodiments, wherein the free siloxane diol comprises a hydroxyl terminated poly(dimethylsiloxane) or hydroxylalkyl terminated poly(dimethylsiloxane).
97. The composition or kit according to any one of the preceding exemplary embodiments, wherein the free siloxane diol comprises a polysiloxane diol having a Mn of at least 1000 g/mol, at least 1200 g/mol, or at least 1500 g/mol.
98. The composition or kit according to any one of the preceding exemplary embodiments, wherein the free siloxane diol comprises a polysiloxane diol having a Mn of at most 10,000 g/mol, at most 9,000 g/mol, at most 8,000 g/mol, at most 7,000 g/mol, at most 6,000 g/mol, or at most 5,000 g/mol.
99. The composition or kit according to any one of the preceding exemplary embodiments, wherein the free siloxane diol is present in an amount of from 0 to 20 wt %.
100. The composition or kit according to any one of the preceding exemplary embodiments, wherein the free siloxane diol is present in an amount of from 1 to 20 wt %.
101. The composition or kit according to any one of the preceding exemplary embodiments, wherein the free siloxane diol is present in an amount of from 1 to 10 wt %.
102. The composition or kit according to any one of the preceding exemplary embodiments, further comprising a free fluorinated diol.
103. The composition or kit according to any one of the preceding exemplary embodiments, wherein the free fluorinated diol comprises 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H, 1H,8H,8H-Perfluoro-3,6-dioxaoctan-1,8-diol, or 1H, 1H,11H,11H-Perfluoro-3,6,9-trioxaundecan-1,11-diol.
104. The composition or kit according to any one of the preceding exemplary embodiments, wherein the free fluorinated diol consists of 1H,1H,4H,4H-Perfluoro-1,4-butanediol, 1H,1H,5H,5H-Perfluoro-1,5-pentanediol, 1H,1H,6H,6H-perfluoro-1,6-hexanediol, 1H,1H,8H,8H-Perfluoro-1,8-octanediol, 1H,1H,9H,9H-Perfluoro-1,9-nonanediol, 1H,1H,10H,10H-Perfluoro-1,10-decanediol, 1H,1H,12H,12H-Perfluoro-1,12-dodecanediol, 1H,1H,8H,8H-Perfluoro-3,6-dioxaoctan-1,8-diol, 1H,1H,11H,11H-Perfluoro-3,6,9-trioxaundecan-1,11-diol, or a blend thereof.
105. The composition or kit according to any one of the preceding exemplary embodiments, wherein the free fluorinated diol is present in an amount of from 0 to 10 wt %.
106. The composition or kit according to any one of the preceding exemplary embodiments, wherein the free fluorinated diol is present in an amount of from 1 to 10 wt %.
107. The composition or kit according to any one of the preceding exemplary embodiments, wherein the free fluorinated diol is present in an amount of from 1 to 6 wt %.
108. A composition formed by combing the elements of the kit according to any one of the preceding exemplary embodiments.
109. A method of forming a component, comprising the step of curing the composition according to any one of the preceding exemplary embodiments.
110. A method of forming a component comprising the steps of:
   a. combining the elements of the kit according to any one of the preceding exemplary embodiments, thereby forming a composition, and
   b. curing the composition.
111. A component formed from the composition, kit, or method according to any one of the preceding exemplary embodiments.
112. A component formed from the composition, kit, or method according to any one of the preceding exemplary embodiments, wherein the component has a thickness of from 1 micrometer to 1 millimeter.
113. A component formed from the composition, kit, or method according to any one of the preceding exemplary embodiments, wherein the component has a concave surface suitable to fit on a surface of the eye.
114. A component formed from the composition, kit, or method according to any one of the preceding exemplary embodiments, wherein the component has a refractive index of from 1.48 to 1.515.
115. A component formed from the composition, kit, or method according to any one of the preceding exemplary embodiments, wherein the component has a refractive index of from 1.48 to 1.50.
116. A component formed from the composition, kit, or method according to any one of the preceding exemplary embodiments, wherein the component, after exposure to 95% relative humidity for 24 hours at 23° C., has a water content of 10 wt % or less.
117. A component formed from the composition, kit, or method according to any one of the preceding exemplary embodiments, wherein the component has an elastic modulus of 500 MPa or greater.
118. A component formed from the composition, kit, or method according to any one of the preceding exemplary embodiments, wherein the component has a Shore D hardness of from 60 to 80.
119. A method comprising the steps of:
   a. providing a component form from the composition, kit, or method according to any one of the preceding exemplary embodiments, and
   b. overmolding a hydrogel in contact with the component.
120. The method according to the previous exemplary embodiment, wherein the hydrogel is a silicone hydrogel.
121. A method comprising the steps of:
   a. providing a component form from the composition, kit, or method according to any one of the preceding exemplary embodiments, and
   b. mounting electrical circuitry on the component.
122. A method comprising the steps of:
   a. providing a component formed from the composition, kit, or method according to any one of the preceding exemplary embodiments, and
   b. mounting electrical circuitry on the component by flip chip mounting.
123. A method comprising the steps of:
   a. providing a component formed from the composition, kit, or method according to any one of the preceding exemplary embodiments, and
   b. mounting electrical circuitry on the component by patterning a conductive material.
124. An ocular device comprising a component formed from the composition, method, or kit according to any one of the preceding exemplary embodiments.
125. An ocular device comprising:
   a. a component formed from the composition, method, or kit according to any one of the preceding exemplary embodiments, and
   b. an electrical circuit mounted on the component.
126. An ocular device comprising:
   a. a component formed from the composition, method, or kit according to any one of the preceding exemplary embodiments, and
   b. a hydrogel molded onto or around the component.
127. An ocular device comprising:
   a. a component formed from the composition, method, or kit according to any one of the preceding exemplary embodiments,
   b. an electrical circuit mounted on the component, and
   c. a hydrogel molded onto or around the component.
128. The ocular device according to any one of the preceding exemplary embodiments, wherein the hydrogel is a silicone hydrogel.

Unless stated otherwise, any expression of wt % is based on the weight of the entire composition, in the case of a composition, or on the weight of the entire kit once all elements are combined, in case of a kit. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. While certain optional features are described as embodiments of the invention, the description is meant to encompass and specifically disclose all combinations of these embodiments unless specifically indicated otherwise or physically impossible.

1. A composition for forming a component of a rigid gas permeable lens comprising:
a. a hydroxyl terminated polyurethane pre-polymer having an average of more than one hydroxyl group per molecule comprising:
i. the residue of an aliphatic diisocyanate, a block comprising polysiloxane and a block comprising hydrophobic poly(alkylene oxide), or
ii. the residue of an aliphatic diisocyanate, a block comprising fluoroalkyl or fluoroalkyl ether, and a block comprising hydrophobic poly(alkylene oxide);
b. a free aliphatic diisocyanate; and
c. a monomeric polyol, or a propoxylate thereof,
wherein the average number of hydroxyl groups of the hydroxyl terminated pre-polymer plus the average number of hydroxyl groups of the monomeric polyol, or a propoxylate thereof is equal to from 4.5 to 5.5.

2. A kit of materials for forming a component of a rigid gas permeable lens comprising:
a. a first element comprising:
i. a hydroxyl terminated polyurethane pre-polymer having an average of more than one hydroxyl group per molecule comprising:
1. the residue of an aliphatic diisocyanate, a block comprising polysiloxane, and a block comprising hydrophobic poly(alkylene oxide), or
2. the residue of an aliphatic diisocyanate, a block comprising fluoroalkyl or fluoroalkyl ether, and a block comprising hydrophobic poly(alkylene oxide);
ii. a monomeric polyol, or a propoxylate thereof,
b. A second element comprising a free aliphatic diisocyanate,
wherein the average number of hydroxyl groups of the hydroxyl terminated pre-polymer plus the average number of hydroxyl groups of the monomeric polyol, or a propoxylate thereof is equal to from 4.5 to 5.5.

3. The composition eft according to claim 1, wherein the hydroxyl terminated polyurethane pre-polymer comprises a mixture of hydroxyl terminated pre-polymers comprising at least one different block.

4. The composition according to claim 1, wherein the hydroxyl terminated pre-polymer comprises an average of from 1.8 to 2 hydroxyl groups per molecule.

5. The composition according to claim 1, wherein the pre-polymer has a number average molecule weight (Mn) of at least 750 g/mol and at most 5000 g/mol.

6. The composition according to claim 1, wherein the hydrophobic poly(alkylene oxide) comprises poly(propylene oxide), poly(tetramethylene oxide), a copolymer of poly(propylene oxide) and poly(tetramethylene oxide), or a mixture thereof.

7. The composition according to claim 1, wherein the monomeric polyol, or a propoxylate thereof comprises glycerol, glycerol propoxylate, pentaerythritol, or pentaerythritol propoxylate.

8. The composition according to claim 1, wherein the monomeric polyol, or a propoxylate thereof is a monomeric polyol that has molecular weight of from 90 to 280 g/mol.

9. The composition according to claim 1, wherein the monomeric polyol, or a propoxylate thereof comprises a propoxylated polyol.

10. The composition according to claim 1, wherein the composition further comprises a chain extender, wherein the chain extender is an alkane diol having from 2 to 20 carbon atoms, wherein one or more carbon atoms may be substituted with oxygen.

11. The composition according to claim 1, further comprising a free siloxane diol, a free fluorinated diol, or a free hydrophobic poly(alkylene oxide) diol.

12. The composition according to claim 1, wherein the composition or kit comprises less than 10 wt % of hydrophilic polymer.

13. The composition according to claim 1, wherein the pre-polymer is present in an amount of from 30 wt % to 80 wt %, the free aliphatic diisocyanate is present in an amount of from 10 wt % to 40 wt %, and the monomeric polyol, or a propoxylate thereof is present in an amount of from 1 wt % to 10 wt %, based on the total weight of the composition.

14. A component formed from the composition according to claim 1.

15. An ocular device comprising:
a. a component formed from the composition according to claim 1,
b. an electrical circuit mounted on the component, and
c. a hydrogel molded onto or around the component.

16. The composition according to claim 1, wherein the pre-polymer comprises less than 5 wt % of hydrophilic polymer.

17. The composition according to claim 1, wherein at least 80 wt % of the blocks in the pre-polymer are blocks comprising polysiloxane or blocks comprising hydrophobic poly(alkylene oxide).

18. The composition according to claim 1, wherein the block comprising hydrophobic poly(alkylene oxide) consists of poly(propylene oxide), poly(tetramethylene oxide), a copolymer of poly(propylene oxide) and poly(tetramethylene oxide), or a mixture thereof.

19. The composition according to claim 1, wherein the pre-polymer comprises the reaction product of:
a. from 15 to 50 wt % of an aliphatic diisocyanate; and
b. from 40 to 80 wt % of diols that comprise a block comprising polysiloxane and/or a block comprising hydrophobic poly(alkylene oxide).

20. A component formed from the composition according to claim 1, wherein the component has a refractive index of from 1.48 to 1.50.
